(19) United States
(12) Patent Application Publication
(10) Pub. No.: US 2013/0204579 A1
(43) Pub. Date: Aug. 8, 2013

(54) State Monitoring Method and System for Wind Energy Installations

(71) Applicants: Peter Volkmer, Dresden (DE); Daniel Volkmer, Dresden (DE); Frank Mueller, Dresden (DE)

(72) Inventors: Peter Volkmer, Dresden (DE); Daniel Volkmer, Dresden (DE); Frank Mueller, Dresden (DE)

(73) Assignee: Robert Bosch GmbH, Stuttgart (DE)

(21) Appl. No.: 13/704,609

(22) PCT Filed: May 24, 2011
(86) PCT No.: PCT/EP2011/002564

§ 371 Date: Feb. 27, 2013

(30) Foreign Application Priority Data
Jun. 16, 2010 (DE) 10 2010 023 898.8
Oct. 9, 2010 (DE) 10 2010 048 008.8

(51) Int. Cl. G06F 17/00

(52) U.S. Cl. CPC G06F 17/00
USPC 702/184; 702/183

(57) ABSTRACT

A method for state monitoring of a wind energy installation, includes normalizing state data relating to a number of different components of the wind energy installation on the basis of a predetermined data norm. The normalized state data is stored in a database device, and the state data which is stored in the database device is assessed by means of processing device, with the state of the components of the wind energy installation being determined on the basis of the assessment.

The present invention relates to a condition monitoring method and a condition monitoring system for wind energy installations.

### PRIOR ART

Condition monitoring systems—CMSs—for wind energy installations are known in the prior art. They are used to continuously monitor the conditions of various components of a wind energy installation, usually rotor blade, drive train, generator, tower, etc., in order to be able to react immediately and to avoid serious consequences in a case of error or damage.

A CMS usually comprises a monitoring device on the component (i.e. normally a computation unit and a number of sensors) which transfers condition data and/or evaluated data to an associated database device. For the purpose of visually displaying the data, a client/server application is usually used, for example a webserver with a browser that accesses it, wherein the webserver in turn accesses the database device and presents and possibly evaluates the data.

Established CMSs operate on a manufacturer-specific basis, however. As a result, the monitoring and operator control proves very confusing for an operator of a wind energy installation, since he needs to open and monitor a separate browser window, for example, for every component. In addition, he needs to get to grips with the operator control of every single CMS. In most cases, there are also no synchronously clocked data available, since the systems operate autonomously.

These disadvantages are amplified accordingly on wind farms, in which CMSs from different manufacturers may also be used for the same components in different installations.

It is therefore desirable to simplify condition monitoring for wind energy installations and particularly wind farms.

### DISCLOSURE OF THE INVENTION

The invention proposes a condition monitoring method and a condition monitoring system for wind energy installations having the features of the independent patent claims. Advantageous refinements are covered by the subclaims and the description below.

### ADVANTAGES OF THE INVENTION

The invention is based essentially on the measure of connecting a central condition monitoring system downstream of conventional—in particular existing—CMSs. This central condition monitoring system comprises a central database for holding condition data from monitored components. Since the data delivered by the conventional CMSs, which are subsequently also referred to as component CMSs, are available in manufacturer-dependent form, the condition monitoring system also comprises an appropriately set-up data standardization device in order to convert the condition data to a standard format and to store them in the database. The data standardization device operates on the basis of a prescribed data standard, for which IEC standard 61400-25 is particularly suitable. This standard is concerned with a standard communication base for the control and monitoring of wind energy installations.

As a result, the component CMSs no longer communicate—as in the prior art—with the separate visual display devices (e.g. webservers) but rather communicate (at least also) with the data standardization device, which receives the data or reads them from the database of the component CMS, standardizes them and stores them in the central database. In addition, the condition monitoring system comprises a processing device in order to rate and present the condition data. The invention significantly simplifies monitoring the condition of wind energy installations. Standard post-editing and visual display can be provided for the condition data from all connected component CMSs. Clarity is increased and the complexity of operator control and monitoring is reduced. The training complexity for personnel is also reduced, since it is also possible to monitor new components or to monitor components with unknown component CMSs within the context of the condition monitoring system according to the invention. This merely requires the data standardization device to be customized and extended if appropriate.

A particular advantage is that condition data which come from different component CMSs can be compared with one another and/or related or correlated to one another. By way of example, it is possible to perform crossover analysis of condition data which relate to the same component but come from different component CMSs, for example in order to verify results or to increase validity. By way of example, vibrations which come from the rotor blade can also be measured in the drive train, and vice versa. The systems in the prior art operate autonomously, which means that the data are not available in synchronous form, in particular. For this reason, correlated evaluations are possible today. By contrast, the invention provides the option of relating the data from different sources to one another chronologically, which provides diverse evaluation options. Preferably, the rating is taken as a basis for producing a representation of the determined condition and/or alarms.

The invention provides standard visual display and also evaluation of condition data which have to date been presented to management in segmented form in different forms of presentation by the component CMSs of different manufacturers. Furthermore, the validity of the individual component CMSs for the different components is successfully improved, since further information relating to the respective condition of a component can be inferred from the data from all components.

It is advantageously possible to provide a standard and high-quality visual display and reporting system for rating the condition of wind energy installations, but also of wind farms and wind parks, having different component CMSs. The increase in the quality of the condition monitoring allows errors and/or damage to be identified earlier, with the result that lower maintenance costs are possibly also incurred. Lengthy down times, which are associated with immense cost disadvantages, can be avoided. Installation safety and installation yield are increased.

On the basis of the standard data collection and visual display, it is also a particularly simple matter to achieve standard error reporting and logging. The modules for error reporting and error logging can be based on a standard system and do not need to be provided repeatedly on a manufacturer-specific basis.

A condition monitoring system according to the invention for wind energy installations is set up, in particular by programming, to carry out a method according to the invention.

The implementation of the invention in the form of software is also advantageous, since it allows particularly low costs, particularly when an executing computation unit is still being used for further tasks and is therefore present anyway. Suitable data storage media for providing the computer program are, in particular, floppy disks, hard disks, flash memories, EEPROMs, CD-ROMs, DVDs and others. It is also possible for a program to be downloaded via computer networks (Internet, intranet, etc.).

Further advantages and refinements of the invention can be found in the description and the accompanying drawing.

It goes without saying that the features cited above and the features yet to be explained below can be used not only in the respectively indicated combination but also in other combinations or on their own, without departing from the scope of the present invention.

The invention is illustrated schematically in the drawing using an exemplary embodiment and is described in detail below with reference to the drawing.

### DESCRIPTION OF THE FIGURES

FIG. 1 shows a diagram of a wind energy installation and of a preferred embodiment of a condition monitoring system according to the invention.

FIG. 1 first of all shows a wind energy installation 100 in schematic form. The wind energy installation 100 comprises individual components, such as a rotor with rotor blades 110, a drive train 120, a tower 130, etc., which are actuated by a control device 101 (PLC). In addition, the components 110, 120, 130 have a respective associated component CMS 111, 121 and 131 for monitoring the condition of the respective component. By way of example, the component CMS 111 for monitoring the condition of a rotor blade may be a system which senses and evaluates vibrations in the rotor blade.

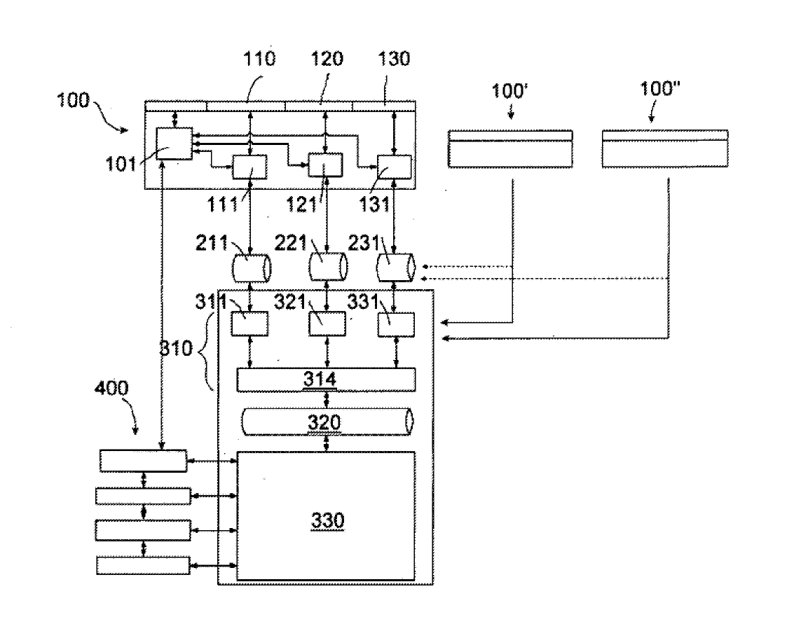

The condition data captured and/or evaluated by the respective component CMSs are transferred from the component CMSs 111, 121, 131 to a respective associated database system 211, 221 and 231. The database systems are usually arranged at a distance from the wind energy installation, for example in a control room. The data are usually transferred in a manufacturer-specific format in which the data are also stored in the respective database system. The transfer is more expediently effected via a WAN (Wide Area Network), for example via DSL.

This is now the basis for a preferred embodiment of a condition monitoring system 300 according to the invention.

The condition monitoring system 300 comprises a data standardization device, which in the present example has a respective server device 311, 312 and 313 for each of the associated component CMSs 111 to 131 or the respective database system 211 to 231 thereof. The data standardization server devices 311 to 313 are each set up, in particular by programming, to read or receive the condition data stored on a manufacturer-specific basis in the database systems 211 to 231 and to standardize them, i.e. put them into a standard form, on the basis of a prescribed data standard. A suitable underlying data standard is particularly IEC standard 61400-25. The connection between the data standardization server devices 311 to 313 and the database systems 211 to 231 is preferably likewise implemented via WAN, which makes simplified implementation possible.

The data standardization device 310 also comprises a common data standardization client device 314 which is set up to access each of the data standardization server devices 311 to 313 and to fetch the condition data standardized therein or to receive said condition data from the data standardization server devices. The data standardization client device 314 stores the standardized condition data in a database device 320. As a result, the condition data stored in the database systems 211 to 231 separately and on a manufacturer-specific basis are therefore now stored—at least insofar as they can be read—in the database device 320 in a standard and manufacturer-independent fashion.

The data standardization server devices 311 to 313 and the data standardization client device 314 are designed on the basis of the OPC UA standard, for example. By providing separate server and client devices, it is possible to keep down the implementation complexity. The data standardization client device 314 preferably likewise accesses the data standardization server devices 311 to 313 via WAN.

The database device 320 has a processing device (VE) 330 connected downstream of it which is set up to display the condition data stored in the database device 320 and also to process them further or to rate them as required. Preferably, the VE 330 is set up to trigger suitable alarms for the management and/or PLC 101. In this context, it is also possible to include user-related evaluations. On the basis of one preferred embodiment of the invention, the VE 330 is set up to correlate condition data which relate to the same component of the wind energy installation 100 but come from different component CMSs. By way of example, vibrations in a rotor blade also propagate themselves into the drive train, with the result that condition data relating to a rotor blade 110 are both delivered by the component CMS 111 and contained in the condition data relating to the drive train of the component CMS 121. In this way, it is possible to achieve a plausibility check for individual condition data, in particular, and an improvement in evaluation precision. The VE 330 may, in particular, comprise a webserver which can be operated and monitored by an operator in conventional fashion and which can trigger alarms, for example as an e-mail and/or SMS.

The VE 330 may also have devices 400 connected downstream of it. By way of example, the devices 400 may comprise a SCADA interface and/or SCADA device, a logging system, an interface for outputting error and/or maintenance reports, an interface to a power supply company, etc. The connection to the devices 400 is usually likewise made via a WAN. There is also expediently a link via WAN between the wind energy installation 100 or the controller 101 thereof and the SCADA device.

Further data standardization server devices (not shown) can be used to connect a condition monitoring system according to the invention to further wind energy installations 100′, 100″, etc. In this way, it is, in particular, also advantageously possible to use a condition monitoring system according to the invention for monitoring a multiplicity of wind energy installations, for example in a wind park.

1. A method for monitoring the condition of a wind energy installation, comprising:
standardizing condition data relating to a number of different components in the wind energy installation on the basis of a prescribed data standard;
storing the standardized condition data in a database device; and
rating the standardized condition data stored in the database device by means of a processing device,
wherein the rating is taken as a basis for determining the condition of the number of different components of the wind energy installation.

2. The method as claimed in claim 1, wherein the condition data relating to the number of different components in the wind energy installation come from at least two different component CMSs.

3. The method as claimed in claim 2, further comprising:
analyzing individually and/or in combination condition data stored in the database device which come from different component CMSs, particularly using correlation methods, for rating the condition of the components.

4. The method as claimed in claim 1, wherein the rating is taken as a basis for producing a representation of the determined condition and/or alarms.

5. A condition monitoring system for wind energy installations, having comprising:
a data standardization device which is configured to standardize condition data relating to a number of different components of the wind energy installation on the basis of a prescribed data standard;
a database device which is configured to store the standardized condition data;
a processing device which is configured to rate the condition data stored in the database device in order to take the rating as a basis for determining and displaying the condition of the components of the wind energy installation.

6. The condition monitoring system as claimed in claim 5, wherein the condition monitoring system is configured to:
standardize the condition data relating to the number of different components in the wind energy installation on the basis of the prescribed data standard,
store the standardized condition data in the database device, and
rate the standardized condition data stored in the database device by means of the processing device.

7. The condition monitoring system as claimed in claim 5, wherein the processing device is configured to take the rating as a basis for producing a representation of the determined condition and/or alarms.

8. The condition monitoring system as claimed in claim 5, wherein the processing device has a SCADA interface, a SCADA device, a logging system, an interface for outputting error and/or maintenance reports and/or an interface to a power supply company connected downstream of it.

9. The condition monitoring system as claimed in claim 5, wherein:
the data standardization device has a respective data standardization server device for each component CMS that is to be linked, and
each data standardization server device is configured to receive the condition data from the component CMS associated with said data standardization server device and to standardize said condition data on the basis of the prescribed data standard.

10. The condition monitoring system as claimed in claim 9, wherein the data standardization device has a common data standardization client device configured to receive the condition data from the data standardization server devices and further configured to store the data in the database device.
